(19) United States
(12) Patent Application Publication
(10) Pub. No.: US 2013/0299337 A1
(43) Pub. Date: Nov. 14, 2013

(54) METHOD AND EQUIPMENT FOR PURIFYING A GAS STREAM

(71) Applicants: Arthur Darde, Houston, TX (US); Alain Briglia, Houston, TX (US); Xavier Traversac, Houston, TX (US); Christophe Szamlewski, Houston, TX (US)

(72) Inventors: Arthur Darde, Houston, TX (US); Alain Briglia, Houston, TX (US); Xavier Traversac, Houston, TX (US); Christophe Szamlewski, Houston, TX (US)

(73) Assignee: L'Air Liquide Societe Anonyme pour l'Etude et l'Exploitation des Procedes Georges Claude, Paris (FR)

(21) Appl. No.: 13/825,698

(22) PCT Filed: Sep. 12, 2011
(86) PCT No.: PCT/FR11/52075

§ 371 Date: Mar. 22, 2013

(30) Foreign Application Priority Data
Sep. 23, 2010 (FR) 1057655

(51) Int. Cl. F25J 3/02; B01D 53/00

(52) U.S. Cl. CPC F25J 3/0266; B01D 53/00
USPC 203/88; 62/617

(57) ABSTRACT

The invention relates to a method for compressing at least two gas streams by means of a single compressor that does not support a fluctuation in flow rate and/or pressure above a critical percentage, said method being characterized in that at least one of the gas streams is fed into a buffer space before being fed into the single compressor.

The present invention relates to a process for compressing at least two gas streams on a single compressor and to the application thereof in a process for purifying a gas stream having carbon dioxide as one of the main components.

One of the means for treating CO₂ involves the purification, by partial condensation, of a CO₂-rich stream typically comprising more than 30 mol % of CO₂. Gas streams enriched in CO₂ are customarily recovered at different pressures at the outlet of the purification unit. Therefore each of the streams recovered is compressed in an intermediate compressor, to the pressure of the stream recovered at the highest pressure, before being mixed with the other streams recovered, in order to be compressed in a final compressor. The final compressor therefore customarily sees a stream formed by the mixture of several streams leaving intermediate compressors.

However, the intermediate compressors may fail. It is therefore necessary to make sure that the sudden loss of molecules at the intake of the final compressor does not make it fail, which would lead to the loss of all the molecules from the various sources.

Note that this problem may be faced from the moment there is one compressor providing the compression of several gas streams. Indeed, if the source of one of the gas streams runs out suddenly, it is necessary to be able to cope with the sudden loss of molecules at the intake of the compressor.

The French patent application published under the no. 2 877 939 discloses a process for compressing at least two gas streams with a single compressor, in which at least one of the gas streams is introduced into a buffer tank before being introduced into the compressor.

The French patent application published under the no. 2 918 579 discloses a process for purifying carbon dioxide in which a liquefied stream enriched in carbon dioxide is vaporized at at least two pressure levels to produce two gas streams; the gas stream at lower pressure then being compressed, then mixed with the second stream and then the mixture is introduced into a final compressor.

Also note that this same problem is encountered as soon as several streams are introduced into equipment that does not support a fluctuation of flow rate and/or of pressure above a critical percentage.

One solution is a process for compressing at least 2 gas streams with a single compressor that does not support a fluctuation of flow rate and/or of pressure above a critical percentage, said process being characterized in that at least one of the gas streams is introduced into a buffer tank before being introduced into the single compressor.

During a reduction of the flow rate of one of the gas streams that leads, within the single compressor, to a fluctuation of flow rate and/or of pressure above said critical percentage, at least one portion of the stream(s) leaving the single compressor may thus be reintroduced into the buffer tank.

The present invention relates to a process for purifying a gas stream comprising a main compound wherein a liquefied product stream, enriched in main compound, is vaporized at at least 2 pressure levels; two gas streams at 2 pressure levels are thus recovered; the first gas stream recovered at the lowest pressure is compressed with the aid of an intermediate compression means to the pressure of the second stream recovered, before being mixed therewith and finally the mixed stream enriched in main compound is introduced into “final” equipment that does not support a fluctuation of flow rate and/or of pressure above a critical percentage, said process being characterized in that the mixed stream of main compound is introduced into a buffer tank before being introduced into the final equipment.

The expression “buffer tank” is understood to mean a tank having a volume that significantly exceeds (at least by 10%) the volume strictly necessary for conveying the molecules into the pipes.

The intermediate compression means may be a compressor dedicated to this compression.

The expression “critical percentage” is understood to mean the percentage of fluctuation of the flow rate beyond which the single compressor suffers a malfunction.

Note that if the final equipment is a compressor, the critical percentage of fluctuation is preferably 1%, 3%, 5%, 10% or 20%, attained in less than 3, 5 or 10 seconds.

Depending on the case, the process according to the invention may exhibit one or more of the following features:
during a reduction of the flow rate of one of the two streams at 2 pressure levels, at least one portion of the stream leaving the final equipment is reintroduced into the buffer tank. The reintroduction of at least one portion of the stream leaving the final equipment into the buffer tank will be referred to in the remainder of the description as “recycle/anti-pumping line”. Specifically, reference is made to pumping of the equipment when it lacks molecules at the intake, which makes the discharge pressure drop.
the liquefied product stream, enriched in main compound, is separated into 3 streams in order to be vaporized at 3 pressure levels; three gas streams at 3 pressure levels are thus recovered; the first and the second gas streams recovered at the lowest pressures are compressed in two intermediate compression means to the pressure of the third gas stream recovered before being mixed therewith;
the pressure of the first stream is between 5 and 6.5 bar a (=5×10⁵ and 6.5×10⁵ Pa); the pressure of the second stream is between 7 and 10 bar a (=7×10⁵ and 10×10⁵ Pa); and the pressure of the third stream is between 8 and 15 bar a (=8×10⁵ and 15×10⁵ Pa);
the main compound is CO₂.
the volume of said buffer tank V, expressed in m³, is greater than Q/100, Q being the flow rate of the mixed stream enriched in main compound, expressed in m³/h.
the final equipment is a final compressor.
   The compression process according to the invention may be carried out in a compression unit comprising:
a) at least 2 lines for conveying the at least 2 gas streams;
b) at least one buffer tank located along one of the conveying lines;
c) a single compressor downstream of the conveying lines and of the buffer tank; and
d) an anti-pumping line that makes it possible to recycle at least one portion of the stream(s) leaving the single compressor to the buffer tank.

Note that the anti-pumping line is in general connected downstream of the compressor, but may optionally be connected upstream of the buffer tank or to the tank itself.

Another subject of the present invention is a unit for purifying a gas stream comprising at least 50 mol % of CO₂, comprising:
i) a first compressor 2 for compressing the gas stream;
ii) a heat exchanger 3 for cooling the compressed gas stream;
iii) a phase separator or a distillation column 6 for separating the carbon dioxide from the compressed and cooled stream;
iv) a divider 8 for separating, into at least 2 streams, preferably 3 streams, the liquid CO₂ 7 resulting from the distillation column 6;
v) at least 2 expansion valves, preferably 3 expansion valves 9, 10 11, for expanding the 2 or 3 divided streams;
vi) at least one intermediate compressor 12, 13 for compressing at least 1 of the 2 or 3 divided streams vaporized in the heat exchanger 3;
vii) a mixer 14 for mixing, downstream of the intermediate compressor, the 2 divided and vaporized streams;
viii) a buffer tank 15 for momentarily storing the mixed stream;
ix) a final compressor 16 downstream of the buffer tank 15 for compressing the mixed stream; and
x) an anti-pumping line 17 that makes it possible to recycle at least one portion of the stream leaving the final compressor to the buffer tank 15.

Note that the mixer may be a simple connection of two pipes to a single pipe.

The present installation preferably comprises a divider for separating, into 3 streams, the liquid CO₂ 7 resulting from the distillation column 6; at least 3 expansion valves 9, 10 and 11 for expanding the 3 divided streams; at least two intermediate compressors 12 and 13 for compressing at least 2 of the 3 divided streams vaporized in the heat exchanger; and a mixer 14 for mixing, downstream of the intermediate compressors, the 3 divided and vaporized streams.

The fact of vaporizing the liquid product at several pressure levels makes it possible to produce the necessary refrigeration and improve the exchange diagram, which is expressed by an optimization of the energy consumption during the subsequent compression of the gas streams recovered.

The anti-pumping line 17 makes it possible to recycle molecules to the intake, resolving the problem of the compression of a flow that is lower than the nominal value. It is however necessary to take into account the reaction time and the opening time of the anti-pumping valve, it being possible for the recycle to take between 1 and 10 seconds to be fully effective. Therefore, the solution recommended in the present invention for avoiding a failure of the final compressor during this transient phase is to install a buffer tank, in line with the intake of the final compressor. During the stopping or decrease of the flow rate of one of the feeds of the compressor, the pressure of the buffer tank will drop since the compressor will continue to withdraw just as many molecules. And as soon as the anti-pumping recycle is activated, the pressure of the buffer tank will go back up.

The sizing of the buffer tank will depend on the ability of the compressor to deal with a drop in pressure at the intake and on the arrival time of the molecules of the anti-pumping line.

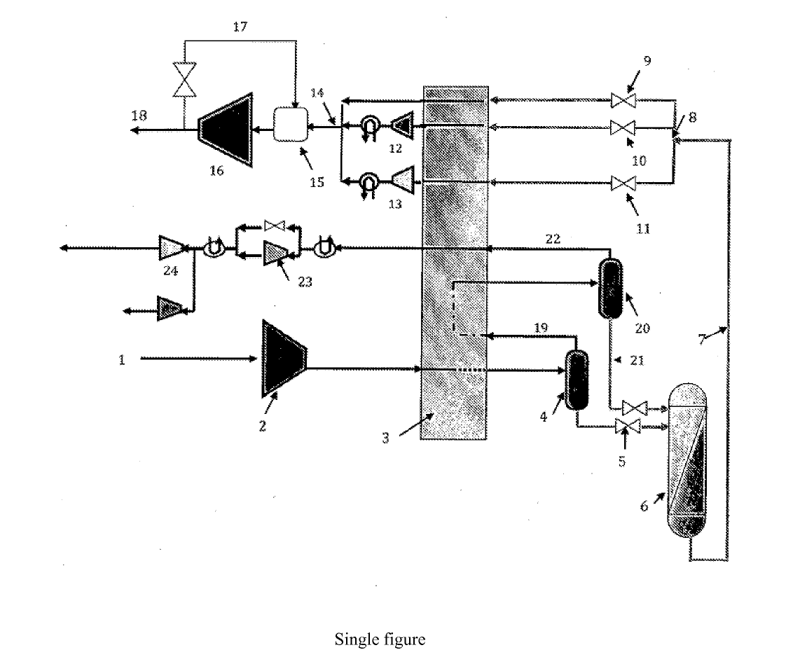

The invention will now be described in detail with the aid of FIG. 1.

FIG. 1 shows apparatus for separating a flow having carbon dioxide 1 as one of the main components, containing at least 50 mol %, or even at least 70 mol % of carbon dioxide and also light impurities, such as nitrogen and oxygen. The flow is compressed in a compressor 2 and then the compressed flow is cooled in a heat exchanger 3. After separation in a separator pot 4, the liquid produced is expanded in a valve 5 and then sent to the top of a column 6. In this column 6, the liquid is separated to form an overhead gas and a bottoms liquid 7 (liquid CO₂). The bottoms liquid 7 is divided into 3 by means of a divider 8. The 3 flows are expanded in valves 9, 10 and 11 at three different pressures. The 3 liquid flows vaporize in the exchanger 3. Two of the three flows are compressed in the intermediate compressors 12 and 13 and the three flows, again at the same pressure, are brought together in a mixer 14. The mixed flow is introduced into a buffer tank and then compressed in a compressor 16. And a stream 18 enriched in CO₂ is recovered.

During a decrease (stopping) of the flow rate of one of the 3 streams at 3 pressure levels, at least one portion of the stream 18 leaving the final compressor is reintroduced into the buffer tank 15 via the anti-pumping line 17.

Preferably, the gas 19 from the separator pot 4 is heated up in the exchanger 7 before being separated again in a separator pot 20. The liquid 21 produced is then sent, after expansion, to the top of the column 6. The gas 22 from the separator pot 20 is heated up in the exchanger 7 and then is expanded in the turbines 23 and 24. And non-condensable gases are recovered at the outlet.

The unit preferably comprises a system for detecting the flow rate upstream of the final compressor. When this system detects a drop in the flow rate, a signal is sent to the anti-pumping line, which opens in order to allow the recycling of at least one portion of the exiting stream to the buffer tank.

### EXAMPLE

A process was chosen in which the liquid CO₂ was divided into 2 streams. Each of the streams has a flow rate of 10,000 m³/h.

One of the 2 flows is stopped. The start-up of the anti-pumping line typically takes 3 seconds: 1 second for detecting the problem and sending the signal to the anti-pumping line+2 seconds for opening the inlet valve of the anti-pumping line and circulating the molecules to the buffer tank.

These 3 seconds represent, in terms of flow: (10 000×3)/3600=8.33 m³. In other words, without the buffer tank, the final compressor would undergo, in 3 seconds, a loss of 8.33 m³ corresponding to a pressure drop of 50%. With a buffer tank of the order of 50 m³, the pressure drop is less than 17%; with a buffer tank of the order of 70 m³, the pressure drop is less than 12%.

Since the final compressor deals with a pressure drop of less than 17% or 12% better than a pressure drop of 50%, the advantage of the buffer tank is easily understood.

1-9. (canceled)

10. A process for purifying a gas stream comprising:
a) separating a liquefied product stream enriched in a main compound into at least two streams,
b) vaporizing the at least two streams, wherein the vaporization occurs at least two pressure levels;
b) recovering at least a first gas stream and a second gas stream, wherein each gas stream is at two different pressure levels, wherein said first gas stream has a lower pressure than said second gas stream;
c) compressing the first gas stream recovered with the aid of an intermediate compression means to the pressure of the second stream,
d) mixing said pressurized at least first gas stream and said second gas
e) introducing said mixed stream into final equipment that does not support a fluctuation of flow rate and/or of pressure above a critical percentage,
wherein the mixed stream of main compound is introduced into a buffer tank before being introduced into the final equipment.

11. The process of claim 10, wherein during a reduction of the flow rate of one of the first stream or the second stream, at least one portion of the stream leaving the final equipment is reintroduced into the buffer tank.

12. The process of claim 10, further comprising separating the liquefied product stream into a first stream, a second stream and a third stream, vaporizing the three streams at three pressure levels; recovering the three gas streams at three pressure, wherein the first steam and the second stream are recovered at the lowest pressures and are compressed in two intermediate compression means to the pressure of the third stream recovered before being mixed therewith.

13. The process of claim 12, wherein the pressure of the first stream is between 5 and 6.5 bar a; the pressure of the second stream is between 7 and 10 bar a;
and the pressure of the third stream is between 8 and 25 bar a.

14. The process of claim 10, wherein the main compound is CO₂.

15. The process of claim 10, wherein the final equipment is a compressor.

16. An apparatus for purifying a gas stream comprising at least 50 mol % of CO₂, comprising:
i) a first compressor for compressing the gas stream;
ii) a heat exchanger for cooling the compressed gas stream;
iii) a phase separator or a distillation column for separating the carbon dioxide from the compressed and cooled stream;
iv) a divider for separating, at least into two streams, the liquid CO₂ resulting from the distillation column;
v) at least 2 expansion valves for expanding the two divided streams;
vi) at least one intermediate compressor for compressing at least one of the two divided streams vaporized in the heat exchanger;
vii) a mixer for mixing, downstream of the intermediate compressor, the two divided and vaporized streams;
viii) a buffer tank for momentarily storing the mixed stream;
ix) a final compressor downstream of the buffer tank for compressing the mixed stream; and
x) an anti-pumping line that makes it possible to recycle at least one portion of the stream leaving the final compressor to the buffer tank.

17. The apparatus of claim 16, wherein the unit comprises:
iv) a divider for separating, into three streams, the liquid CO₂ resulting from the distillation column;
v) at least three expansion valves for expanding the three divided streams;
vi) at least two intermediate compressors for compressing at least two of the three divided streams vaporized in the heat exchanger;
vii) a mixer for mixing, downstream of the intermediate compressors, the three divided and vaporized streams.

18. The apparatus of claim 16, wherein the unit comprises at least one detection system located upstream of the final compressor and that makes it possible to detect a drop in the flow rate or pressure and to send a signal to the opening valve of the anti-pumping line.
